(19) United States
(12) Patent Application Publication
(10) Pub. No.: US 2003/0031990 A1
(43) Pub. Date: Feb. 13, 2003

(54) Achieve

(76) Inventor: Carlos Aclan Venegas JR., Los Angeles, CA (US)

Correspondence Address: CARLOS A. VENEGAS, JR., 871 S. LUCERNE BLVD. NO.7, LOS ANGELES, CA, 90005, US

(21) Appl. No.: 10/191,341

(22) Filed: Jul. 9, 2002

Related U.S. Application Data
(60) Provisional application No. 60/310,673, filed on Aug. 8, 2001.

(51) Int. Cl. G09B 19/02

(52) U.S. Cl. 434/188

(57) ABSTRACT

Two to four players can play. Players will use sign tiles (16), sign roller (1), solution boards (4), racks (4), achievement medals (5) and number tiles (100) for level I and (120) for level II. Sign tile has two different math symbols on the face of the tile and either one can be used in the equation. The player who will play first will roll the sign roller and the sign on top will be the math sign to be used. The players will form the math equations on their solution boards using their number tiles and sign tiles identical to the math sign on top of the sign roller. Players need to replace the pieces of number tiles they used in every play. The players to form four correct math equations on the solution board will earn the 1^{st} achievement medal. The player who earns two medals wins.

### FIELD OF INVENTION

This invention relates to a unique and simple mathematical board game where math operational symbols namely, a plus sign, a multiplication sign, a minus sign and a division sign will be given an equal probability of being selected in a play.

### BACKGROUND OF THE INVENTION

There are numerous mathematical board games available in the United States and other countries which provide limited testing of the players mathematical skills, limited in giving the four mathematical symbols namely a plus sign, a minus sign, a multiplication sign and a division sign equal chances of appearance when a die is rolled. Others are too complicated while others limit the development of analytical thinking, problem solving skills and logical reasoning of the players.

For example, U.S. Pat. No. 6,056,553 to Huang discloses a math playing and training system limited to addition and subtraction only.

U.S. Pat. No. 5,120,226 to Tsai discloses a mathematical teaching aid that pertains to multiplication only.

U.S. Pat. No. 3,523,377 to Gardner discloses a game where there are two sets of dice, the first set has a series of numbers, while the second die has on four of its six faces math operational symbols, namely a plus sign, a minus sign, a multiplication sign, and a division sign and on the other two faces equals sign. The game is played by rolling the two sets of dice and then arranging them so that a mathematically correct equation is displayed.

U.S. Pat. No. 3,314,168 to Heckman shows a game where there are two sets of dice, one has numerical values on each face of each die, and the other set having mathematical operational symbols on four of the six faces of each die, namely a plus sign, a minus sign, a multiplication sign and a division sign. There is also a set of cards having a numerical value thereon. The game is played by turning over a card to display a numerical value, then rolling the two sets of dice, and attempting to arrange the numerical values with the mathematical operation symbols so that the numerical equivalent of the numbers along with the math operational symbols equals the number on the card.

U.S. Pat. No. 5,176,381 to Winters discloses a game where there is a first set of die, each of which has the numerical values of one through six thereon, and a second set of die each of which has a plus, minus, division and multiplication signs thereon. The two sets of dice are discharged into a playing surface in a random pattern and then the individual dice members of the first and second set are placed in an alternating pattern so that when the mathematical operations are performed as indicated in the alternating arrangement of the two sets of dice, a desired maximum value is obtained.

Therefore, there is a great need for a math board game that can cover mathematical operations including addition, multiplication, subtraction and division to be presented in a simple game device that is enjoyable and educational at the same time. A math game wherein the mathematical symbols namely a plus sign, a multiplication sign, a minus sign and a division sign will be given an equal probability of being displayed when the device is rolled. A math game with the abundance of mathematical operational symbols available to players.

### SUMMARY OF THE INVENTION

It is an object of the present invention to overcome the deficiencies of the prior art and provide a novel and challenging mathematical board game requiring chance and skill. It is still another object of the present invention specifically Level I, to provide a mathematical board game that would enhance the ability of the players to add, multiply, subtract and divide numbers at the players own level of math skill.

For level II, it is another object of the present invention to increase the creativity and skill of the players in adding, multiplying, subtracting and dividing numbers due to a predetermined number of pieces of number tiles to be used in forming the math equation as required by the sign tiles.

It is another object of the present invention to provide a method of mathematical board game which has an abundance of math symbols available because sign tiles have two different math symbols on the face of the sign tiles, one math symbol is vertically positioned upward and the other math symbol is vertically positioned downward, either one of the two math symbols can be used in forming a math equation accordingly.

The present invention provides a simple and unique mathematical board game device and methods of playing including a rectangular sign roller with four math symbols on the face of the device, namely a plus sign, a multiplication sign, a minus sign and a division sign. This unique sign roller will give the four mathematical symbols an equal probability of appearance when the sign roller is rolled.

It is another object of the present invention to motivate players by providing achievement medals to be earned by the player winning the game.

These and other components of the present invention will be apparent from the detailed description below.

### BRIEF DESCRIPTION OF THE DRAWINGS

FIG. 1 are the number tiles from 0 to 9 for Level I.

FIG. 2 are the number tiles from 0 to 9 for Level II.

FIG. 3 is the sign roller, a rectangular device with four (4) sides with math signs of multiplication (×), division (−), addition (+) and subtraction (−).

FIG. 4 are the sign tiles for Level I, each tile has two different mathematical operational symbols, one math symbol is vertically positioned upward and the other math symbol is vertically positioned downward, either one of the two math symbols can be used in the math equation.

FIG. 5 are the sign tiles for Level II, each tile has two different mathematical operational symbols, one math symbols is vertically positioned upward and the other math symbol is vertically positioned downward, either one of the two math symbols can be used in the math equation.

There are numbers indicated in the corer of the sign tiles upward and downward which represent the required exact number of pieces of number tiles to be used in forming the math equation.

FIG. 6 are the racks to be used by the players.

FIG. 7 is the box of the game with dividers.

FIG. 8 is the box cover.

FIG. 9 are the solution boards for Level I & II, one for each player.

FIG. 10 are the achievement medals for Level I & II, to be earned by the player who played four correct math equations on the solution board.

### DETAILED DESCRIPTION OF THE DRAWINGS

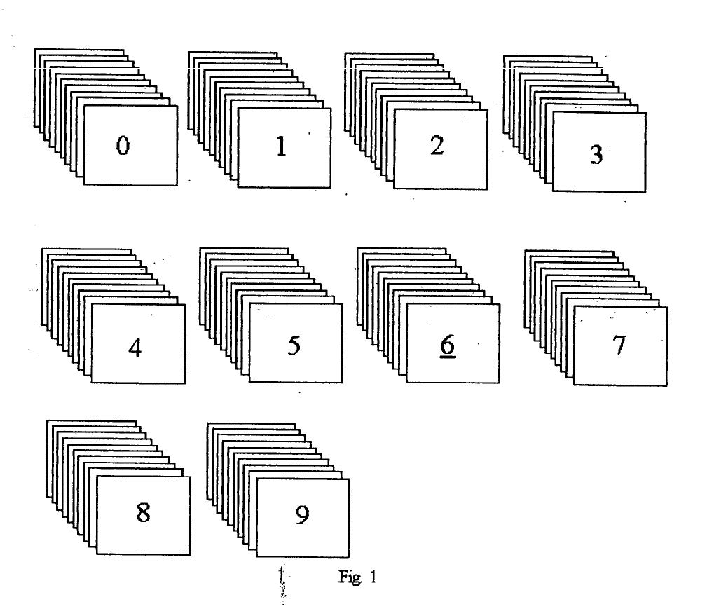

In FIG. 1 are the number tiles from 0 to 9. These tiles are for Level I. The tiles have ten (10) pieces each number. Example, tile number zero (0) has ten (10) pieces of identical tiles and so with tiles numbers one (1) to nine (9), they all have (10) pieces of identical number tiles. The total number of pieces of all these tiles is one hundred (100). After shuffling the tiles faced down, each player has to get nine (9) pieces. The player with the highest similar number of number of tiles will be the first to play followed by the player to his left. Example: if one player has three number 7 and the other player has three number 5, the player with three number 7 will play first. If the player has no triple or more identical numbers, the player with the highest double number will start the play. After every play, the player needs to replace the number of pieces of the number tiles he used in that play. Players should always have nine (9) pieces of number tiles. Number tiles are played on the squares of the solution board marked number tiles. Tile number zero (0) cannot be used individually nor by itself as a divisor, a multiplier, an addend or a subtrahend.

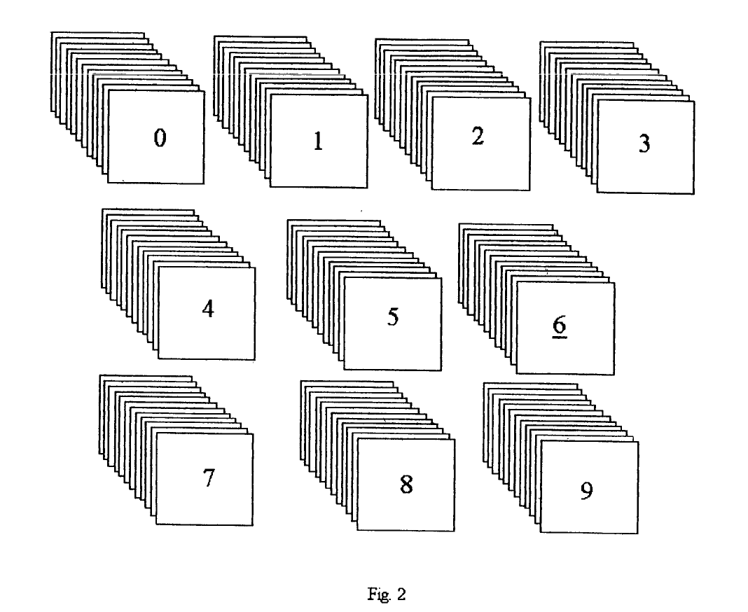

In FIG. 2 are the number tiles from 0 to 9. These tiles are for Level II. The tiles have twelve (12) pieces each number. Example, tile number zero (0) has twelve (12) pieces of identical number tiles and so with tiles with numbers one (1) to nine (9), they all have twelve (12) pieces of identical number tiles. The total of all tiles is one hundred twenty (120) pieces. After shuffling the tiles faced down, each player has to get twelve (12) pieces. The player with the highest similar number of number tiles will be the first to play followed by the player to his left, (same rule as Level I). After every play, the player needs to replace the number of pieces of the tiles he used in that play. Players should always have twelve (12) pieces of number tiles. Number tiles are played on the squares of the solution board marked number tiles. Tile number zero (0) cannot be used individually nor by itself as a divisor, a multiplier, a multiplicand, an addend or a subtrahend.

The players can add another level of play. Parents or adults can play with their kids by using Level II sign tiles while the kids will use the Level I sign tiles. The parents will get twelve (12) pieces of number tiles and four (4) pieces Level II sign tiles while the kids will get nine (9) pieces of number tiles and four (4) Level I sign tiles. Since we are giving our kids a headstart, the kids with the highest similar number tiles will start the play (same rule as Level I). The players in this mixed Level will use the number tiles of Level II (120) pieces. Other rules of Level I and Level II will apply.

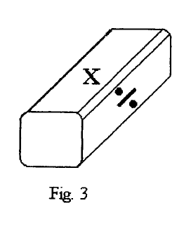

In FIG. 3 is the sign roller with four (4) sides with signs of multiplication (×), division (−), addition (+) and subtraction (−). This will be used in Level I & II. The player will roll the sign roller like rolling a die and the sign on top will be the math process to do. If he does not have the sign to be played (from his sign tiles), he will lose his turn to play and will pass the play to the next player to his left who will then roll the sign roller for his own play. If he has the math sign, he will form the math equation on the solution board using his tiles. He needs to recite it to complete the play. After completing the play, a player needs to replace the number of pieces of his number tiles he used in that play. The play should be made correctly. If there was a mistake, a player loses his turn to play and should pass the play to the next player to his left. Other players should be ready to challenge the correctness of every play made.

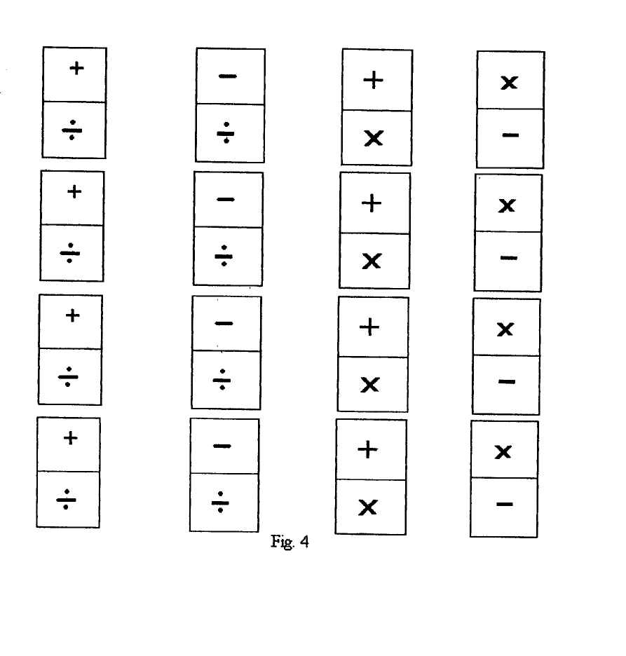

In FIG. 4 are the sign tiles, each tile has two different math symbols on the face of the sign tile, one math symbol is vertically positioned upward and the other math symbol is vertically positioned downward. Either one of the two math symbols on the face of the sign tile can be used in the math equation accordingly. These tiles will be used in Level I. Each math sign combinations has four (4) identical sign tiles. The total number of pieces of these sign tiles is sixteen (16). After shuffling the sign tiles faced down, the players will get four (4) pieces of the sign tiles to be arranged in the racks. To play, the player will roll the sign roller and the sign on top will be the math process to do. He will form the math equation using his number tiles and sign tile. The math symbol on the sign tile to be used in the math equation will be put on top position and placed on the “go” square of the solution board while the math sign not to be used in the math equation will be on the downward position and is automatically placed on the “stop” square of the solution board.

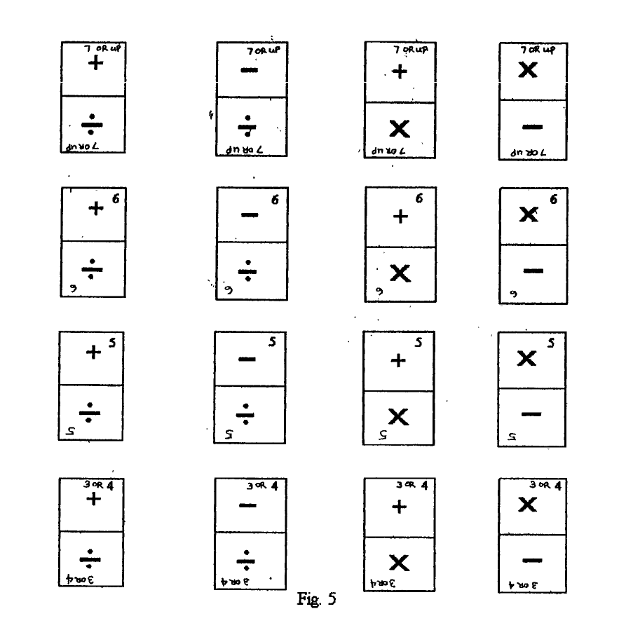

In FIG. 5 are the sign tiles, each tile has two different math symbols on the face of the sign tile, one math symbol is vertically positioned upward and the other math symbol is vertically positioned downward. Either one of the two math symbols on the face of the sign tile may be used in the math equation accordingly. These sign tiles will be used in Level II. Each math symbols combination on the sign tile has four (4) other similar sign tiles combinations. The total number of pieces of these sign tiles is sixteen (16). There are numbers indicated in the corner of the sign tiles, upward and downward, these numbers represent the predetermined number of pieces of the number tiles to be used in the play.

After shuffling the sign tiles faced down, a player needs to get four (4) pieces of these tiles to be arranged in his rack. To play, the player will roll the sign roller and the sign on top of the sign roller will be the math process to do. He will form the math equation using his number tiles and sign tile. The math symbol on the sign tile to be used in the math equation will be put on top position and placed on the “go” square of the solution board while the math sign not to be used will be on the downward position and is automatically placed on the “stop” square of the solution board.

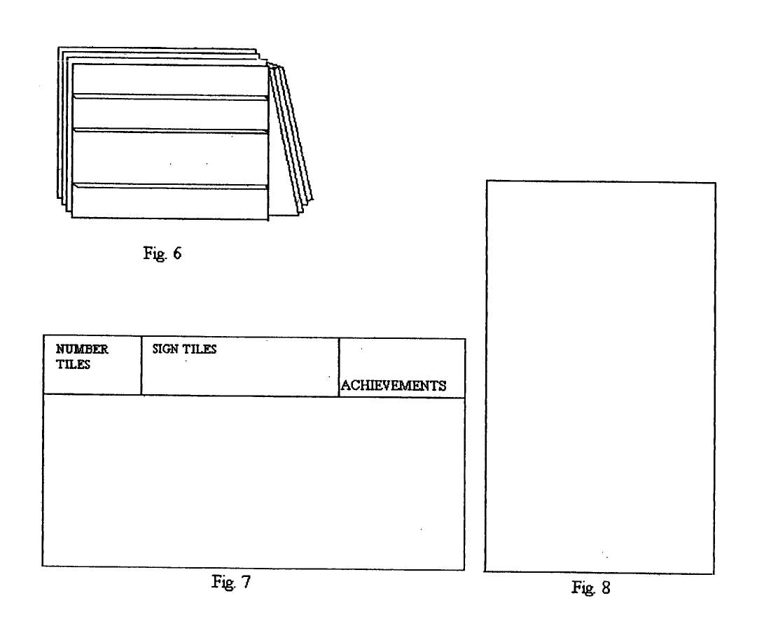

In FIG. 6 are racks for Level I & II. Each player will get one (1) rack to put and arrange his number tiles and sign tiles. There are four (4) racks, one for each player.

In FIG. 7 is the box of the game. It has a divider for the number tiles, sign tiles and achievements. After every game, the players will put the number tiles and the sign tiles in the box faced down and prepare for the next game after shuffling the tiles.

On the next game, the player to the left of the winner will play first.

In FIG. 8 is the cover of the box.

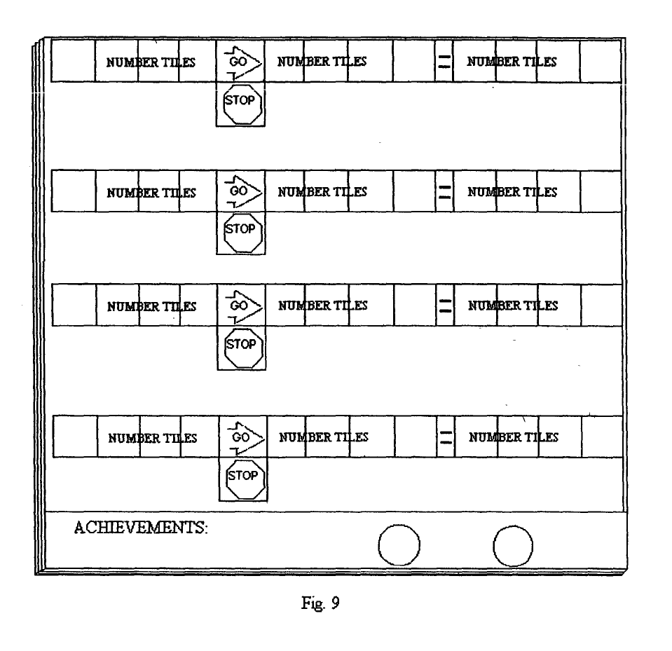

In FIG. 9 are the solution boards for Level I & II, to be used by the players to form their math equations. There are four (4) boards, one for each player. To play, the player will place the number tiles and sign tiles on the solution board. The math sign of the sign tile to be used in the math equation should be placed in the upward position and placed on the “go” square while the math sign not to be used in the math equation will be on the downward position and is automatically placed on the “stop” square. Number tiles are played on the squares of the solution board marked number tiles.

Achievements earned by the players are also placed in the lower portion of the solution board as properly marked.

Another option is to put a pouch on the solution board where the downward sign, the math sign not to be used, will be inserted, hence only the upward sign, the sign to be used in the equation is on top position and is visible.

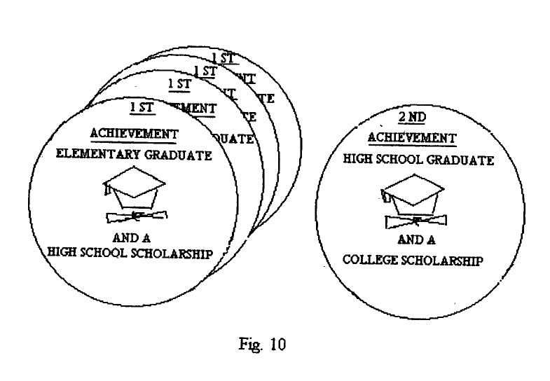

In FIG. 10 are the achievements to be earned by the players for Level I & II. The first player to complete four correct math equations on the solution board will earn the 1st achievement medal. Every player needs to earn the 1st achievement before he could earn the 2nd achievement medal. There are four pieces of 1st achievement medal and one piece of 2nd achievement medal. The first player to earn two achievement medals, the 1st and the 2^{nd}, wins the game.

The math games described and claimed herein may comprise physical embodiments of the game board and the playing pieces. The components, instead of being presented in real form, can be presented in simulated form such as in a computer display or in a TV show version of the game. Other changes may be made in the construction and the operation of the various components and elements. For example, a timer can be added, fractions can be included and a point score can be used for each number tile played. Therefore, it should be understood that other and further modifications, apart from those shown or suggested may be made within the spirit and scope of this invention.

What is claimed is:

1. A mathematical board game, comprising:
a. a rectangular device bearing mathematical operational symbols on four rectangular faces namely a plus sign, a multiplication sign, a minus sign and a division sign
b. a plurality of sign tiles for level I, each sign tile has two different mathematical operational symbols on the face of the sign tile, one math symbol is vertically positioned upward and the other math symbol is vertically positioned downward, whereby either one of the two math symbols can be used in the math equation accordingly
c. a plurality of sign tiles for level II, each sign tile has two different mathematical operational symbols on the face of the sign tile, one math symbol is vertically positioned upward and the other math symbol is vertically positioned downward, said math symbols have numbers indicated in the corner, said numbers predetermine the exact number of pieces of number tiles to be used in the math equation, whereby either one of the two math symbols can be used in the math equation accordingly
d. a plurality of solution boards having a flat surface for receiving thereon a plurality of tile pieces, said flat surface including a plurality of equally sized playing square for number tiles and a plurality of two vertically positioned upward and downward squares for receiving thereon sign tiles, said upward square marked “Go” will receive the math symbol to be used in the math equation while the said downward square marked “Stop” will receive the math symbol of the sign tile not to be used in the math equation, the plurality of the playing squares for number tiles, sign tiles and squares with equal signs are arranged on the face of the solution board in four (4) horizontal directions parallel to each other.
